(19) United States
(12) Patent Application Publication
(10) Pub. No.: US 2008/0017680 A1
(43) Pub. Date: Jan. 24, 2008

(54) BICYCLE BASKET

(76) Inventor: Sheng-Kai LEE, Taichung City (TW)

Correspondence Address: LEONG C LEI, PMB # 1008, 1867 YGNACIO VALLEY ROAD, WALNUT CREEK, CA, 94598, US

(21) Appl. No.: 11/458,694

(22) Filed: Jul. 20, 2006

(51) Int. Cl. B62J 11/00

(52) U.S. Cl. 224/412

(57) ABSTRACT

A bicycle basket which mainly contains a metallic top ring, metallic bottom ring, a bottom screen positioned inside the bottom ring, and a number of rigid metallic wires arranged perpendicularly between the top and bottom rings supporting the bottom screen. A number of plastic sticks are also arranged perpendicularly between the top ring and the bottom ring. A number of plastic strips are woven sequentially and tightly from bottom to top and laterally through the plastic sticks and the metallic wires so as to completely cover the side of the bicycle basket.

### TECHNICAL FIELD OF THE INVENTION

The present invention generally relates to a bicycle basket, and more particularly to a rattan-like bicycle basket made of metallic and plastic parts.

### DESCRIPTION OF THE PRIOR ART

Most commercially available bicycle baskets are made by welding metallic wires together. Even though the bicycle baskets are painted to have various colors, the paint usually peels off after a period of usage, exposing the metallic wires inside and causing the metallic wires to become rusted. The rusts not only make the bicycle basket less appealing, but also may stain the objects carried in the bicycle basket. Additionally, the metallic basket is heavier.

There are also bicycle baskets made by weaving rattan splints. The rattan bicycle baskets are of course lighter and free from rusts. However, mildew may grow on the rattan splints after the bicycle basket is exposed to rain or water and, once this happens, the mildew is difficult to remove. Then, after a period of usage, the bicycle basket may even become rotten and require replacement, which is not economical. On the other hand, dusts and debris are easily trapped and accumulated on the bottom of the rattan bicycle basket.

### SUMMARY OF THE INVENTION

The major objective of the present invention therefore is to provide a bicycle basket that appears to be rattan woven but is actually metallically structured so as to achieve both the benefits of appealing appearance and lighter weight of rattan baskets and stronger robustness of metallic baskets.

Another objective of the present invention is to provide a bicycle basket whose basic structure is formed by metallic wires and rings and whose space is defined by plastic sticks and strips woven together. The metallic and plastic parts of the bicycle basket can be recycled separately.

Yet another objective of the present invention is to provide the bicycle basket having a metallic screen at the bottom so that water, debris, and dusts will not accumulate inside the bicycle basket.

To achieve the foregoing objectives, the bicycle basket of the present invention mainly contains a metallic top ring, a metallic bottom ring, a bottom screen positioned inside the bottom ring, and a number of rigid metallic wires arranged perpendicularly between the top and bottom rings supporting the bottom screen. A number of plastic sticks are also arranged perpendicularly between the top ring and the bottom ring. A number of plastic strips are woven sequentially and tightly from bottom to top and laterally through the plastic sticks and the metallic wires so as to completely cover the side of the bicycle basket.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing the basic structure of a bicycle basket according to an embodiment of the present invention.

FIG. 2 is a perspective diagram showing the result of an intermediate step in forming a bicycle basket from the basic structure of FIG. 1.

FIG. 3 is perspective diagram showing the result of another intermediate step in forming a bicycle basket from the partial product of FIG. 2.

FIG. 4 is perspective diagram showing the completed bicycle basket from the partial product of FIG. 3.

FIG. 5 is perspective diagram showing a bicycle basket according to another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

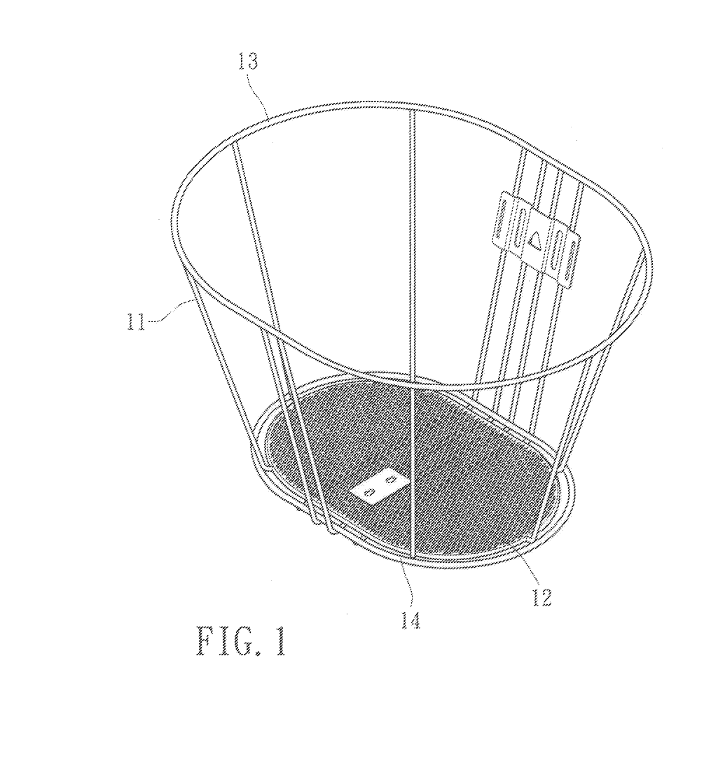

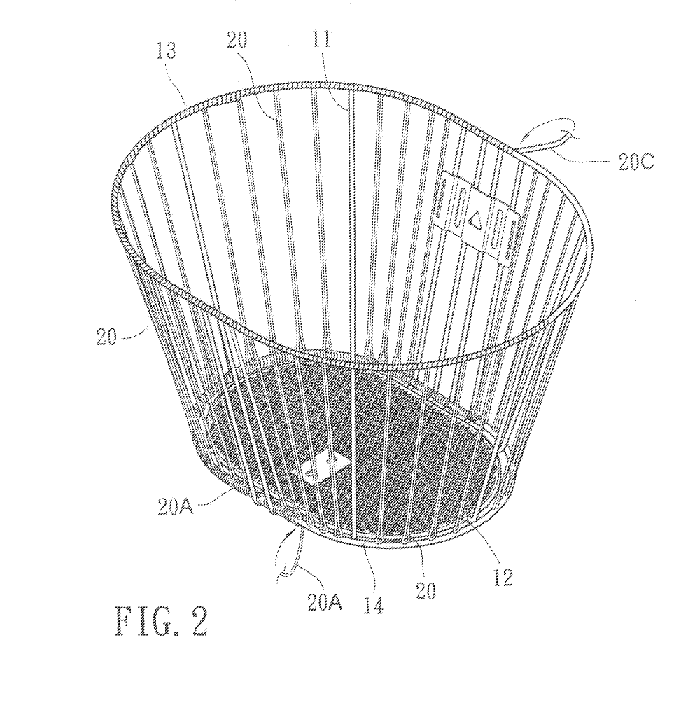

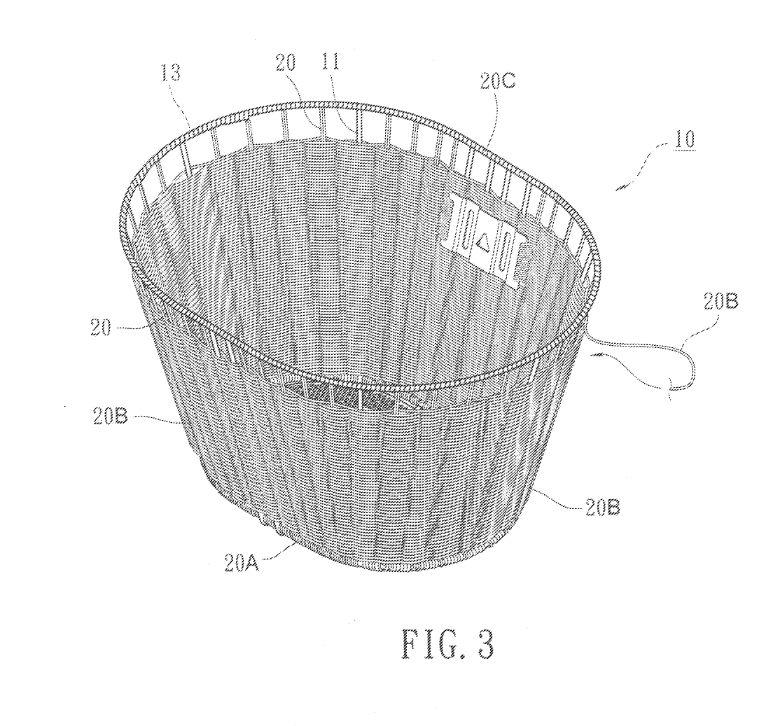

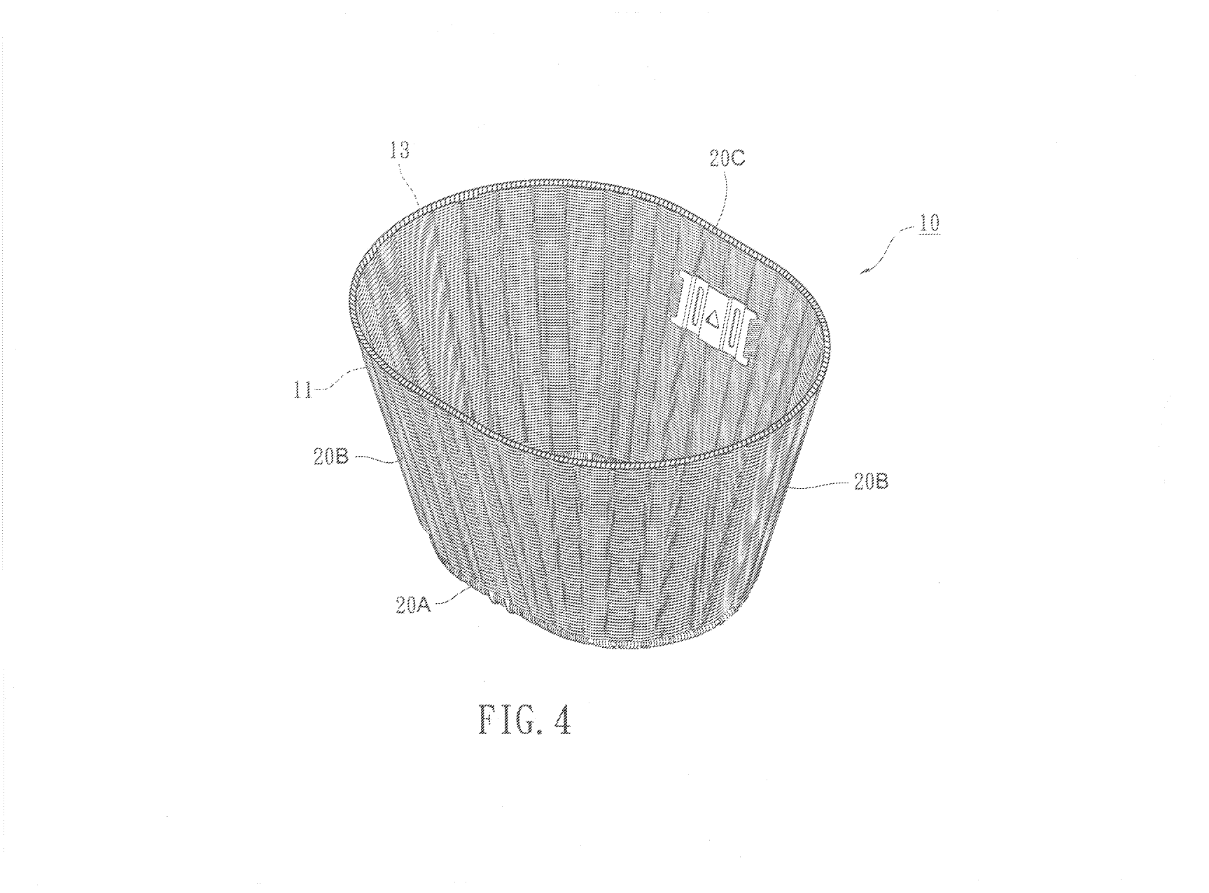

As shown in FIG. 1, a bicycle basket 10 according to an embodiment of the present invention mainly contains a metallic top ring 13 and a metallic bottom ring 14 positioned laterally and substantially parallel to each other. A bottom screen 12 is then positioned inside the bottom ring 14 and is supported by and joined to a number of rigid metallic wires 11 arranged perpendicular between the top ring 13 and the bottom ring 14. The metallic wires 11, the top ring 13, and the bottom ring 14 jointly form the basic structure of the present embodiment. Then, as shown in FIG. 2, a number of plastic sticks 20 are also arranged between the top ring 13 and the bottom ring 14 and substantially parallel to the metallic wires 11. The top and bottom rings 13 and 14 are then completely wound by plastic strips 20C and 20A respectively. Further, as shown in FIG. 3, a number of plastic strips 20B are woven sequentially and tightly from bottom to top and laterally through the plastic sticks 20 and the metallic wires 11 so as to completely cover the side of the bicycle basket 10 of the present embodiment. The completed product is then shown in FIG. 4.

From the foregoing description, the advantages of the present invention can be summarized as follows. First, the basic stricture of the bicycle basket 10 is formed by a number of rigid metallic wires 11 and rings 13, 14 so that the bicycle basket 10 will not be easily deformed even when carrying heavy objects. Secondly, the space of the basket 10 is mainly formed by the plastic sticks 20 and the plastic strips 20B, which is light weighted. Thirdly, the laterally woven plastic strips 20B through the metallic wires 11 further enhance the robustness of the bicycle basket 10. Furthermore, the growth of mildew is prevented by the use of plastic material such as the plastic sticks 20 and the plastic strips 20A, 20B, and 20C. Additionally, the metallic wires 11 and the plastic parts 20, 20A, 20B, and 20C can be recycled separately when the bicycle basket is damaged.

The metallic screen 12 at the bottom of the bicycle basket 10 contains a lot of meshes so that debris and dusts can be carried away by rain or water. The water, rain, debris, and dusts therefore will not accumulate.

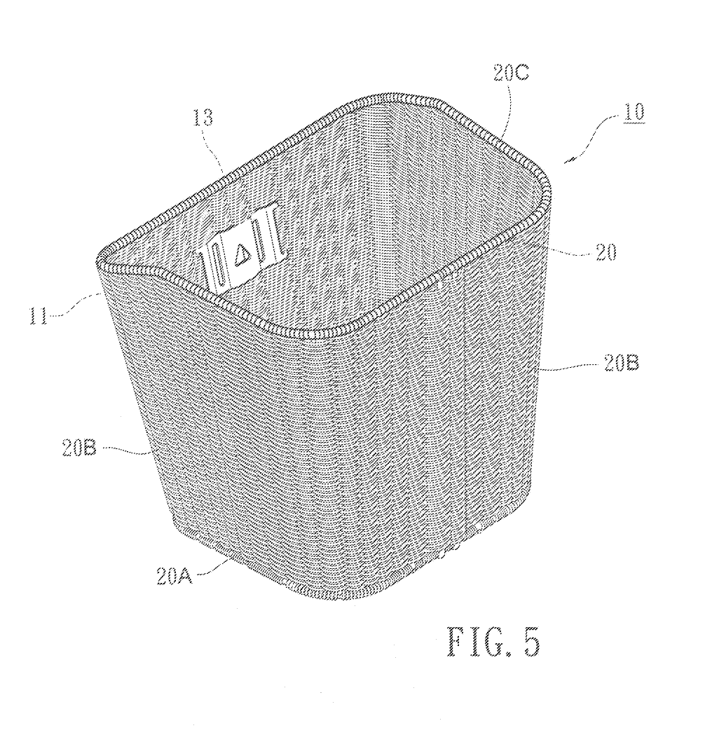

Based on the same principle, bicycle baskets of various form factors can be made. For example, as shown in FIG. 5, a rectangular bicycle basket 10 is formed by adopting rectangular rings 13 and 14. The side of the bicycle basket 10 is formed using the same method by the same plastic sticks 20 and strips 20B. In other words, the parts can be mass-produced and can be used to build various types of bicycle baskets. Compared to conventional rattan baskets, the present invention further has advantages such as having easily obtainable parts with identical quality.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A bicycle basket comprising:
a metallic top ring and a metallic bottom ring positioned laterally and substantially parallel to each other;
a plurality of metallic wires arranged perpendicular between said top and bottom rings;
a plurality of plastic sticks arranged substantially perpendicular between said top and bottom rings and parallel to said metallic wires; and
a plurality of plastic strips woven between said top and bottom rings laterally through said plastic sticks and said metallic wires.

2. The bicycle basket according to claim 1, further comprising:
a bottom screen positioned inside said bottom ring and supported by said metallic wires.

3. The bicycle basket according to claim 1, wherein said top and bottom rings are wound by a plurality of plastic strips.
